(19) United States
(12) Patent Application Publication
(10) Pub. No.: US 2025/0149843 A1
(43) Pub. Date: May 8, 2025

(54) PEDESTAL-FREE, THULIUM-DOPED OPTICAL FIBER

(71) Applicant: nLIGHT, Inc., Camas, WA (US)

(72) Inventor: Manoj KANSKAR, Portland, OR (US)

(21) Appl. No.: 18/933,935

(22) Filed: Oct. 31, 2024

Related U.S. Application Data
(60) Provisional application No. 63/547,031, filed on Nov. 2, 2023.

(51) Int. Cl. H01S 3/067; H01S 3/16

(52) U.S. Cl. CPC H01S 3/06716; H01S 3/06729; H01S 3/1616

(57) ABSTRACT

An optical fiber includes a doped core doped with thulium and a doped cladding surrounding the doped core. The doped cladding is doped with a second dopant. The doped cladding has a thickness between about 45 μm-650 μm. The doped core and the doped cladding establish a numerical aperture within a range of about 0.04-0.20.

### CROSS-REFERENCE TO RELATED APPLICATION(s)

This United States Non-Provisional Patent Application relies on and claims priority to U.S. Provisional Patent Application Ser. No. 63/547,031, the entire contents of which are incorporated herein by reference.

### FIELD OF THE INVENTION

The present invention encompasses, inter alia, pedestal-free, thulium-doped optical fiber. The optical fiber may be employed to transmit high power laser light, for example.

### DESCRIPTION OF THE RELATED ART

Thulium-doped (Tm-doped) optical fibers are known in the prior art.

One difficulty with Tm-doped optical fibers lies in the incorporation of a pedestal within the optical fiber.

A general desire has developed to develop optical fibers that are Tm-doped but that avoid the inclusion of a pedestal therein.

### SUMMARY OF THE INVENTION

The present invention seeks to address one or more deficiencies in the prior art.

Specifically, the present invention provides for a Tm-doped optical fiber that excludes a pedestal.

In one contemplated embodiment, the present invention provides for an optical fiber that includes a doped core where the core is doped with thulium. The optical fiber also includes a doped cladding surrounding the doped core where the cladding is doped with a second dopant. The doped cladding has a thickness between about 45 μm-650 μm. The doped core and the doped cladding establish a numerical aperture within a range of about 0.04-0.20.

In another embodiment, the numerical aperture is within a range of about 0.04-0.14.

Still further, it is contemplated that the numerical aperture may be within a range of about 0.15-0.19.

In a further variation, the numerical aperture is within a range of about 0.16-0.18.

Still further, it is contemplated that the numerical aperture may be at least one of about 0.04, 0.05, 0.06, 0.07, 0.08, 0.09, 0.10, 0.11, 0.12, 0.13, 0.14, 0.15, 0.16, 0.17, 0.18, 0.19, or 0.20.

It is contemplated that the doped cladding has a thickness between about 150 μm-250 μm.

In one embodiment, the doped cladding has a thickness between about 550 μm-650 μm.

It is also contemplated that the doped cladding may have a thickness that is selected from a group comprising: 45 μm, 50 μm, 100 μm, 150 μm, 200 μm, 250 μm, 300 μm, 350 μm, 400 μm, 450 μm, 500 μm, 550 μm, 600 μm, and 650 μm.

The second dopant may be germanium, in one embodiment.

In another embodiment, the second dopant is aluminum.

It is also contemplated that the doped core of the optical fiber may be made from a first plurality of canes that are heated and drawn.

In another contemplated embodiment, the doped cladding includes a second plurality of canes that are heated and drawn.

Still further, the optical fiber may be constructed so that the doped core comprises a first plurality of canes and the doped cladding comprises a second plurality of canes, where both the first plurality of canes and the second plurality of canes are heated and drawn.

Separately, it is contemplated that the first plurality of canes may encompass a third plurality of canes and a fourth plurality of canes. If so, the third plurality of canes are contemplated to be doped with thulium at a first concentration and the fourth plurality of canes are contemplated to be doped with thulium at a second concentration. Here, the first concentration is not equal to the second concentration. Moreover, the fourth plurality of canes may be undoped.

In another contemplated configuration, the optical fiber is constructed so that the second dopant is germanium and the second plurality of canes encompasses a fifth plurality of canes and a sixth plurality of canes. Here, the fifth plurality of canes is doped with germanium at a third concentration, and the sixth plurality of canes is doped with germanium at a fourth concentration. The third concentration is not equal to the fourth concentration. It is contemplated that the sixth plurality of canes may be undoped.

It is also contemplated that the optic fiber may be made such that the second dopant is aluminum and the second plurality of canes include a seventh plurality of canes and an eighth plurality of canes. Here, the seventh plurality of canes may be doped with aluminum at a fifth concentration and the eighth plurality of canes may be doped with germanium at a sixth concentration. The fifth concentration is not contemplated to be equal to the sixth concentration. As before, the eighth plurality of canes may be undoped.

Still further advantages and features of the present invention will be made apparent by the discussion presented herein.

### BRIEF DESCRIPTION OF THE DRAWINGS

The present invention will now be described in connection with the drawings appended hereto, in which:

FIG. 1 is a graphical cross-section of a typical example of a thulium-doped optic fiber according to the prior art;

FIG. 2 is a refractive index fiber profile for the thulium-doped optic fiber illustrated in FIG. 1;

FIG. 3 is a graph that plots the refractive index profile, thulium concentration, and first order mode profile for the optic fiber shown in FIG. 1;

FIG. 4 is a graphical, end view of a first embodiment of an optic fiber according to the present invention;

FIG. 5 is a perspective, graphical representation showing the use of canes to manufacture the optic fiber according to the present invention;

FIG. 6 is a graphical, end view of a second embodiment of an optic fiber manufactured according to the present invention;

FIG. 7 is a graphical, end view of a third embodiment of an optic fiber manufactured according to the present invention;

FIG. 8 is a graphical, end view of a fourth embodiment of an optic fiber manufactured according to the present invention;

FIG. 9 is a is a graphical, end view of a fifth embodiment of an optic fiber manufactured according to the present invention; and

FIG. 10 is a flow chart illustrating one contemplated method for manufacturing the optic fiber according to the present invention.

### DETAILED DESCRIPTION OF EMBODIMENT(S) OF THE INVENTION

The present invention will now be described in connection with several examples and embodiments. The present invention should not be understood to be limited solely to the examples and embodiments discussed. To the contrary, the discussion of selected examples and embodiments is intended to underscore the breadth and scope of the present invention, without limitation. As should be apparent to those skilled in the art, variations and equivalents of the described examples and embodiments may be employed without departing from the scope of the present invention.

In addition, aspects of the present invention will be discussed in connection with specific materials and/or components. Those materials and/or components are not intended to limit the scope of the present invention. As should be apparent to those skilled in the art, alternative materials and/or components may be employed without departing from the scope of the present invention.

In the illustrations appended hereto, for convenience and brevity, the same reference numbers are used to refer to like features in the various examples and embodiments of the present invention. The use of the same reference numbers for the same or similar structures and features is not intended to convey that each element with the same reference number is identical to all other elements with the same reference number. To the contrary, the elements may vary from one embodiment to another without departing from the scope of the present invention.

Still further, in the discussion that follows, the terms “first,” “second,” “third,” etc., may be used to refer to like elements. These terms are employed to distinguish like elements from similar examples of the same elements. For example, one fastener may be designated as a “first” fastener to differentiate that fastener from another fastener, which may be designated as a “second fastener.” The terms “first,” “second,” “third,” are not intended to convey any particular hierarchy between the elements so designated.

It is noted that the use of “first,” “second,” and “third,” etc., is intended to follow common grammatical convention. As such, while a component may be designated as “first” in one instance, that same component may be referred to as “second, “third,” etc., in a separate instance. The use of “first,” “second,” and “third,” etc., therefore, is not intended to limit the present invention.

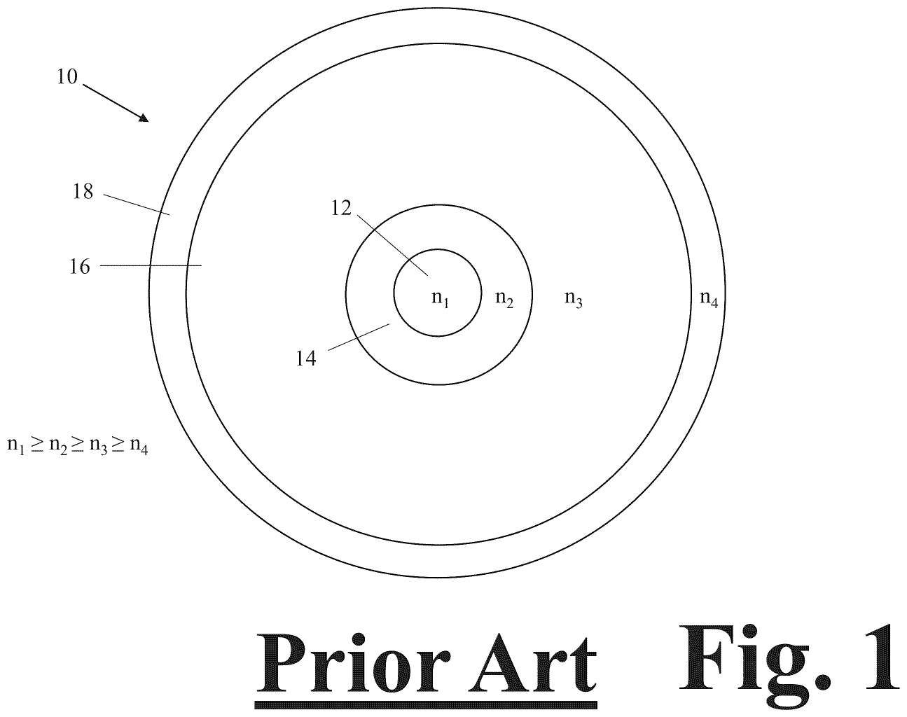

FIG. 1 is a graphical, end view of an optic fiber 10 with a construction known in the prior art. Specifically, the optic fiber 10 is a thulium-doped (“Tm-doped”) optic fiber 10 that includes Tm-doped core 12 surrounded by a germanium-doped (Ge-doped) region 14. As detailed herein, the Ge-doped region 14 is commonly referred to as a “pedestal.” The Ge-doped region 14 is surrounded by a silica cladding 16, which is not doped. The silica cladding 16, in turn, is surrounded by a fluorine-doped (F-doped) cladding 18.

As should be apparent to those skilled in the art, silica is the base material commonly used to create optical fibers. Silica also is referred to as silicon dioxide (SiO₂). Silica is the primary component of glass.

When a dopant is added to silica, the refractive index of silica changes. The refractive index (“RI”) (also referred to as the Index of Refraction) is a measure of how fast light travels through a given medium. The RI also is used as a measure of how much a light ray bends when passing from one medium to another.

Mathematically, the RI is represented as a ratio between two different velocities: the velocity of light in vacuum divided by the velocity of light in a given medium. This relationship is represented by the equation: n=c/v, where “n” is the refractive index for the material, “c” is the speed of light in a vacuum, and “v” is the speed of light in the medium (such as silica).

By way of introduction and example, the refractive index for silica (glass) is 1.5.

When silica is doped with a material, such as an element (e.g., thulium, Tm), the refractive index, n, is changed by the addition of the dopant to the silica. By using different quantities of dopant, the refractive properties of the silica may be adjusted, or tuned. Different refractive indices may be used to achieve various different goals in the context of optics.

With continued reference to FIG. 1, the core 12 is understood to transmit laser light therein. So that the core 12 is capable of achieving total internal reflection (“TIR”), the cladding 14 has a refractive index, n₂, that is lower than the refractive index, n₁, of the core 12.

It is not uncommon for some light to be transmitted through a secondary structure, such as the cladding 16. The cladding 16 has a RI, n₃. So that light is retained in the cladding 16 from one end of the optic fiber 10 to the other, the cladding 16 is surrounded by another cladding 18 with an RI, n₄. So that the light is transmitted from one end of the optic fiber 10 to the other, the RI for the cladding 18 is less than the RI for the cladding 16.

As should be apparent from the foregoing, the RIs for each of the various regions of the optic fiber 10 progressively decrease from the center of the optic fiber 10 to the edge. As such, it is understood that n₁≥n₂≥n₃≥n_{4.}

For clarity, it is noted that Tm-doped optic fibers 10 are referred to as “active” optic fibers. An “active” optic fiber means that, when light is pumped into the optic fiber 10 from a suitable laser diode, e.g., light with a wavelength of 793 nm, light will be present in the cladding 16 (with the refractive index n₃). The Tm-doped core 12 will absorb some of the light and generate light with a wavelength near the 2 micrometer region of the electromagnetic spectrum. It is this light that the Tm-doped core 12 guides and transmits.

In connection with the optic fiber 10, it is noted that the Tm-doped core 12 is surrounded by the Ge-doped region 14 to ensure that a sufficiently a low numerical aperture (“NA”) is established to achieve, effectively, a single mode operation in large mode area (“LMA”) optic fiber. The Ge-doped region 14 is able to affect the transmission in the optic fiber 10 such that the optic fiber 10 behaves in a manner that is similar to or the same as a purely single mode fiber.

It is also known that the pedestal 14 may be doped with aluminum (Al) rather than germanium.

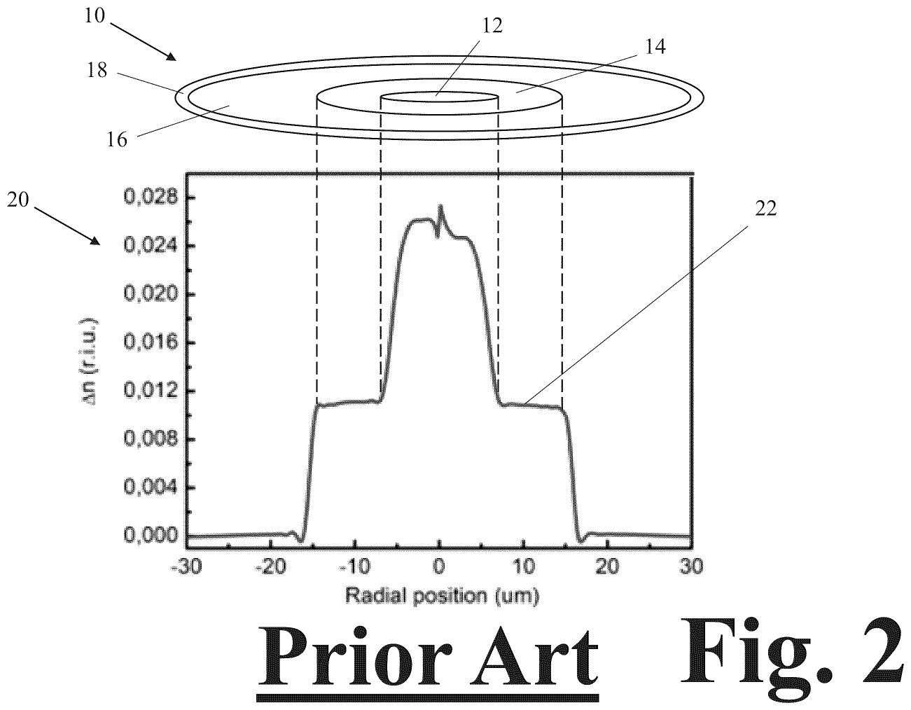

FIG. 2 is a graphical representation of one possible refractive index profile 20 that may be associated the optic fiber 10 illustrated in FIG. 1. In this illustration, a representation of the cross-section of the optic fiber 10 is included to facilitate an understanding of the correlation between the refractive index profile 20 and the optic fiber 10.

As illustrated, the refractive index profile associated with the Ge-doped region 14 exhibits a generally flat profile extending across the radial distance commensurate with the radial extent of the Ge-doped region 14. This flat profile is referred to as an optical “pedestal” 22. Since the optical pedestal 22 corresponds to the thickness of the Ge-doped region 14, the Ge-doped region 14 also is referred to as “the pedestal” 14, as noted above.

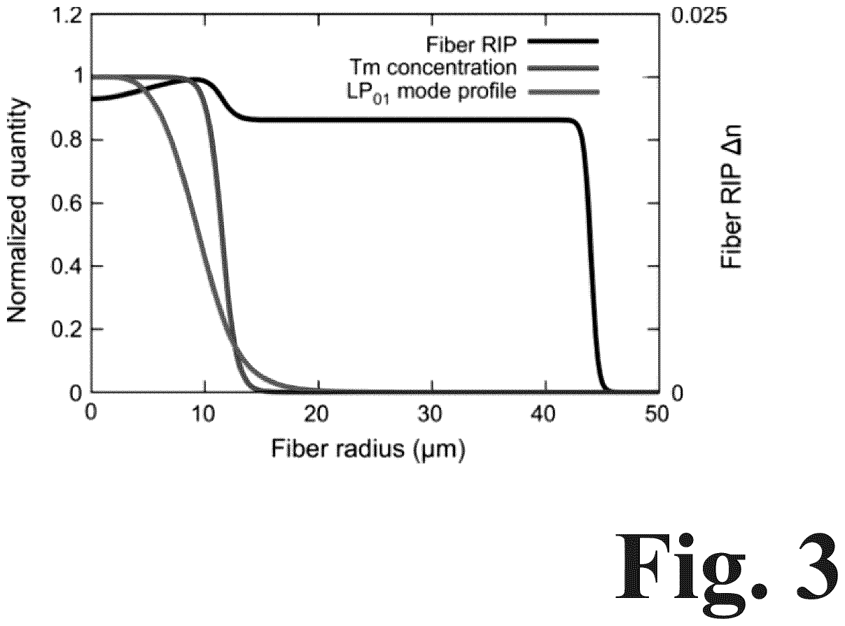

FIG. 3 provides a graph that plots the Refractive Index Profile (“RIP”), the Tm concentration, and the first order (“LP₀₁”) mode profile associated with operation of the optic fiber 10. From FIG. 3, the dimension of the Ge-doped region or pedestal 14 become apparent. Specifically, the pedestal 14 extends from a radial position of about 13 μm to about 43 μm within the optic fiber 10. This dimension is indicated by the depiction of the fiber RIP. As such, the pedestal has a thickness of about 30 μm.

There are at least two undesirable effects that the pedestal 14 may have on the operation of the optic fiber 10. First, the pedestal 14 may introduce one or more opportunities to excite one or more higher order modes in the optic fiber 10. Second, the pedestal 14 also may trap pump light.

As should be understood by those skilled in the art, a higher order mode is detrimental to the operation of the optic fiber 10. In particular, it is possible that the higher order mode may introduce modal beating within the core 12 that might initiate a Thermal Modal Instability (“TMI”). A TMI interferes with optimal operation of the optic fiber 10.

Trapped pump light also is detrimental to the operation of the optic fiber 10. Moreover, trapped light is not easily removed from the pedestal 14. While clad light strippers may be used to remove trapped light from a cladding, this is not possible with the construction illustrated in FIG. 1, because the pedestal 14 is buried close to the core 12.

The challenges associated with the incorporation of the pedestal 14 into the optic fiber 10 are amplified when the optic fiber 10 is modified to incorporate a Chirally Coupled Core (“3C”) that has additional side core(s).

With continued reference to FIG. 1, those skilled in the art understand that it is not feasible to create an optic fiber 10 that excludes the pedestal 14 using existing manufacturing techniques. In other words, via existing manufacturing techniques, it is not possible to create an optic fiber 10 without a pedestal 14 that establishes a suitable NA to permit the Tm-doped core 12 to operate effectively as a single mode fiber.

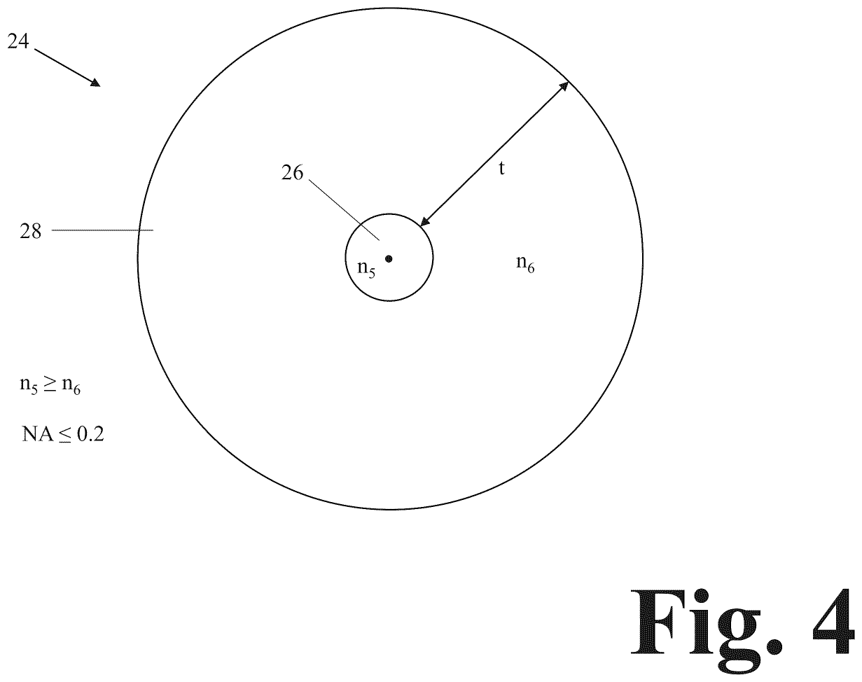

FIG. 4 provides a graphical cross-section of a Tm-doped optic fiber 24 according to the present invention.

The present invention rectifies, among other things, the challenges associated with the drawbacks associated with the optic fiber 10 including the pedestal 14. In particular, the optic fiber 24 provides for the construction of a Tm-doped fiber without incorporating a pedestal 14 around the core 12.

The optic fiber 24 of the present invention includes a doped core 26 surrounded by a doped cladding 28.

The doped core 26 is contemplated to be made from silica doped with Tm. As such, the doped core 26 also is referred herein as the Tm-doped core 26. The doped core 26 has an RI of n₅.

The doped cladding 28 is contemplated to be made from silica doped with either Ge or Al. In the discussion that follows, the doped cladding 28 may be referred to as the Ge-doped cladding 28 or as the Al-doped cladding 28. It is noted that reference to either Ge or Al is not intended to be limiting of the invention, because one or both of the dopants may be employed without departing from the scope of the present invention. The doped cladding 28 has an RI of n₆.

As indicated in FIG. 4, n₅≥n₆.

It is noted that the variables “n₅” and “n₆” are used as a convenient naming convention to refer to the refractive indices of the doped core 26 and the doped cladding 28, respectively, so that the refractive indices n₅, n₆ are distinguishable from the refractive indices n₁-n₄ that are used in connection with the discussion of the optic fiber 10.

With respect to the doped cladding 28, the use of either Al- or Ge-doped silica is contemplated to achieve conditions where the NA is ≤0.2. While a value of ≤0.2 for the NA is a target value, it is noted that the NA value may be within a range from 0.04-0.2. In other words, it is contemplated that NA is ≤0.04-0.20. Other ranges for NA also are contemplated to fall within the scope of the present invention. Those values include, but are not limited to: 0.04-0.14, 0.15-0.19, 0.16-0.18, and 0.17. The NA also may be equal to any of the following values without departing from the scope of the present invention: 0.04, 0.05, 0.06, 0.07, 0.08, 0.09, 0.10, 0.11, 0.12, 0.13, 0.14, 0.15, 0.16, 0.17, 0.18, 0.19, and 0.20. Moreover, any ranges for NA that are defined by these same values, as endpoints, are contemplated to fall within the scope of the present invention.

In connection with the calculation of the value of NA, laser light will propagate in the core of an optic fiber so long as the light enters at an angle within the acceptance cone of the optic fiber, which is defined by the acceptance angle θₘₐₓ. The NA of the optic fiber involves the RI of the core (n_{core}) and the RI of the cladding (n_{clad}) and is defined by the following equation: NA=n·sin θₘₐₓ=√(n_{core}²-n_{clad}²).

It is noted that the present invention is not intended to be limited solely to the addition of Al or Ge dopants to the silica in the doped cladding 28. Other dopants may be employed without departing from the scope of the present invention. Moreover, it is contemplated that more than one dopant may be incorporated into the doped cladding 28 as well. For example, the doped cladding 28 may incorporate both Ge and Al as dopants.

Regardless of the material selected for the dopant, the dopant for the doped core 26 and the dopant for the doped cladding 28 are understood to establish a value for NA that is ≤0.2, as discussed above. This includes the ranges and the specific values listed above.

As should be apparent by comparing FIG. 4 with FIG. 1, one aspect of the optic fiber 24 of the present invention is the elimination of the pedestal 14. Another way to look at the optic fiber 24 of the present invention is to consider that the silica cladding 16 and the cladding 18 of the prior art optic fiber 10 have been replaced with a Ge-doped (or Al-doped) cladding 28 in their entireties. In either case, the optic fiber 24 eliminates the pedestal 14.

The prior art does not teach or suggest such a construction, because of the time and expense associated with such a construction. Specifically, current manufacturing techniques permit the deposition of a thin Ge-doped pedestal 14 around the core 12. However, they do not permit the formation of more than a thin layer as the Ge-doped region 14. The present invention solves this problem.

As discussed in connection with FIG. 3, the pedestal 14 extends from a radial position that is 13 μm to a position that is 43 μm from a central axis of the optical fiber 10. As such, the pedestal 14 has a thickness of 30 μm. As noted, prior art manufacturing techniques do not facilitate the formation of a thicker pedestal 14.

In contrast to the prior art, the present invention includes a doped cladding 28 with a thickness t that is contemplated be between 45 μm and 650 μm. In other words, the thickness t of the doped cladding satisfies the relationship: 45 μm≤t≤650 μm. In specific embodiments, this thickness t is contemplated to be 45 μm, 50 μm, 100 μm, 150 μm, 200 μm, 250 μm, 300 μm, 350 μm, 400 μm, 450 μm, 500 μm, 550 μm, 600 μm, and 650 μm. These specific thicknesses are understood to encompass a range of ±10 μ. As such, if the thickness of the doped cladding 28 is identified as 100 μm, this is understood to encompass a range of 90 μm to 110 μm.

The thickness t of the doped cladding 28 also is contemplated to fall within any range defined by the specific thicknesses t identified. For example, in one embodiment, the thickness t of the cladding may be between 150 μm-250 μm. In another embodiment, the thickness t may be between 500 μm and 650 μm.

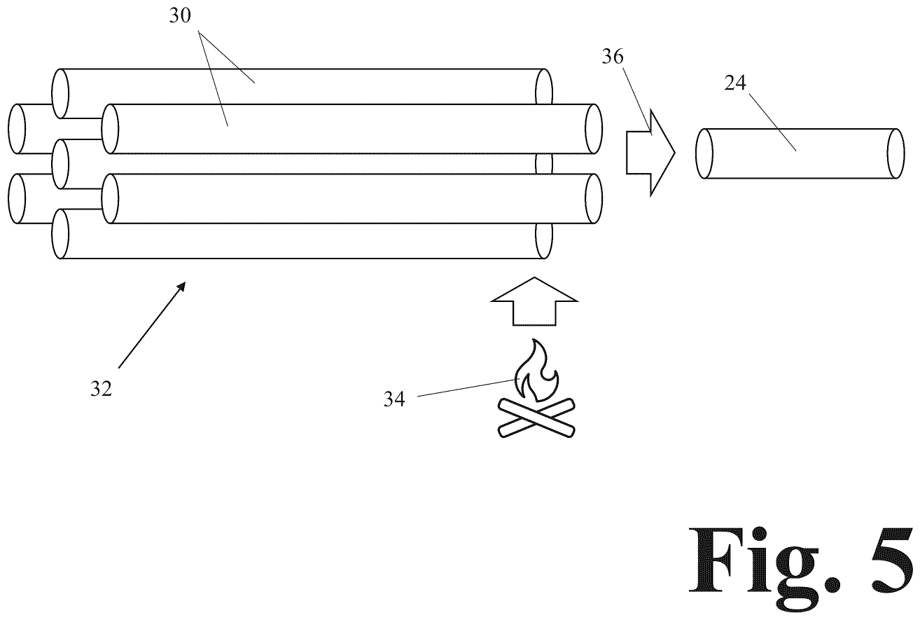

With reference to FIG. 5, the present invention relies on the formation of the optic fiber 24 using “canes” 30. “Canes” 30 are sticks of silica that are typically much larger in diameter than the diameter of a single optic fiber 24. To produce the optic fiber 24, the canes 30 are grouped, as illustrated in FIG. 5, into at least one cane bundle 32. The cane bundle 32 is then subjected to heat 34. The cane bundle 32 is then drawn into the optic fiber 24, as indicated by the arrow 36. When the canes 30 are heated and drawn, the canes 30 coalesce to form a unitary structure. The unitary structure is the optic fiber 24.

Alternatively, it is contemplated that multiple cane bundles 32 may be formed first. These cane bundles 32 may then be drawn into multiple cane fibers that may be combined subsequently to form the optic fiber 24.

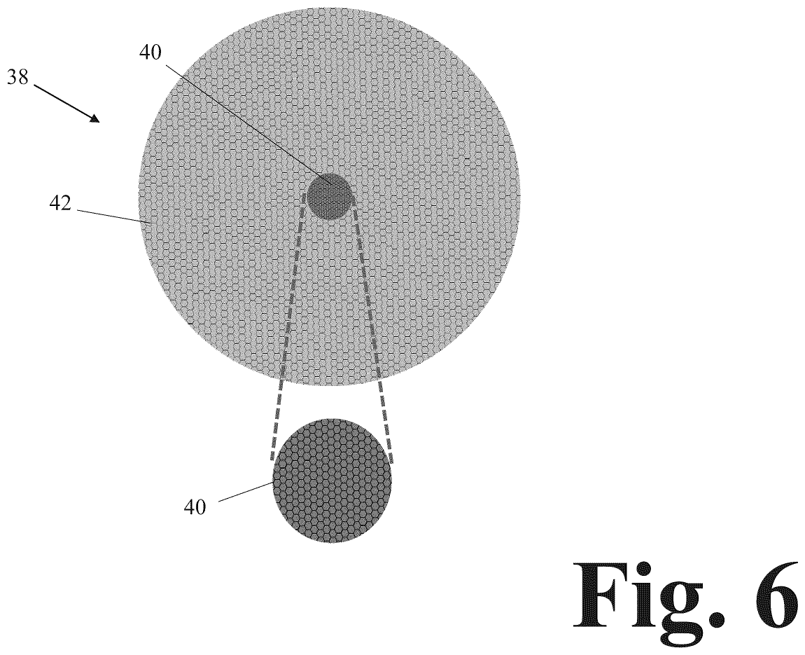

FIG. 6 is a graphical cross-section of a first embodiment of an optic fiber 38 created using canes 30 consistent with FIG. 5.

The optic fiber 38 includes a doped core 40 and a doped cladding 42. As discussed above, the doped core 40 is contemplated to be doped with Tm and the doped cladding 42 is contemplated to be doped with Ge or Al. The selection of the dopant for the doped core 40 and the doped cladding 42 is understood to establish a value for NA that is ≤0.2 consistent with the discussion presented hereinabove.

In FIG. 6, the doped core 40 and the doped cladding 42 are illustrated in a manner where a pattern is illustrated in the depiction of the doped core 40 and in the depiction of the doped cladding 42. The pattern is provided to acknowledge that the construction of the doped core 40 and the doped cladding 42 are made from individual canes that have been drawn down from a cane bundle 32 into the optic fiber 38.

For clarity, the pattern is provided merely for discussion purposes. As noted above, the structure of the optic fiber 38 will be unitary and uniform, because the canes 30 will have merged during heating 34 and drawing 36. Therefore, it is understood that, in most instances, a pattern will not be discernable in the optic fiber 38.

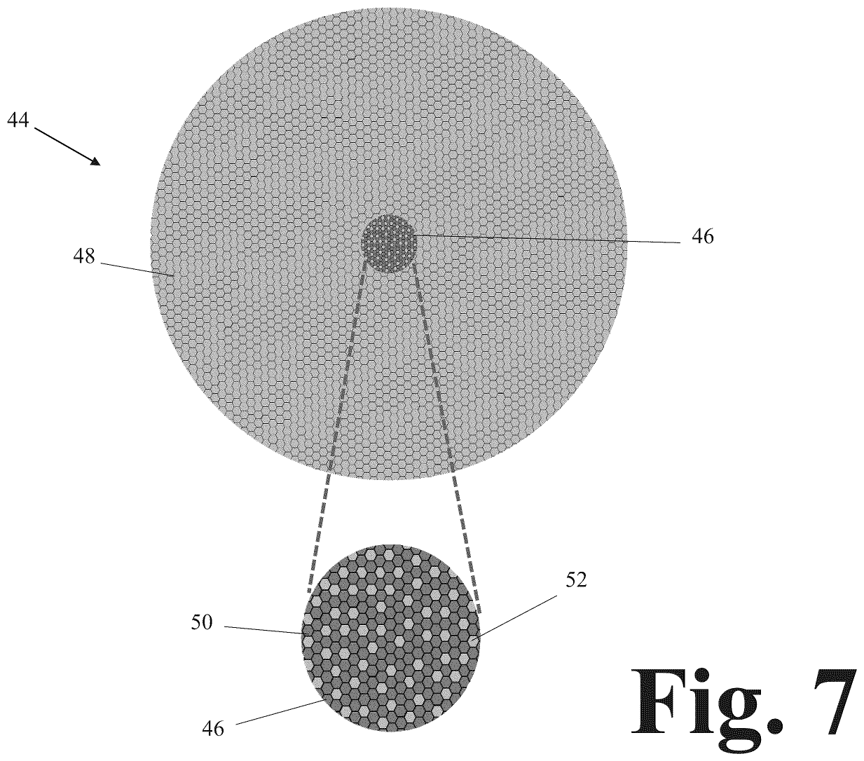

FIG. 7 is a graphical cross-section of a second embodiment of an optic fiber 44 created using canes 30 as illustrated in FIG. 5.

The optic fiber 44 includes a doped core 46 and a doped cladding 48. The doped core 46 is contemplated to be doped with Tm and the doped cladding 48 is contemplated to be doped with Ge or Al, as discussed above. As before, the selection of the dopant for the doped core 46 and the doped cladding 48 is understood to establish a value for NA that is ≤0.2.

In this second embodiment, the doped core 46 has a construction that differs from the doped core 40 illustrated in FIG. 6. Specifically, the doped core 46 is constructed from first canes 50 and second canes 52, which differ compositionally from one another. This is indicated by the differently highlighted canes 50, 52 in the enlarged cross-section of the doped core 46 that is provided in FIG. 7. It is noted that the sizes of the canes 50, 52 are less than or equal to 5 times the wavelength of light being transmitted in the doped core 46 at a maximum. In one contemplated embodiment, the sizes of the canes 50, 52 have a minimum dimension equal to the wavelength of the light being transmitted by the doped core 46.

For the doped core 46, it is contemplated that the first canes 50 will be Tm-doped, where the Tm doping concentration is a known quantity. The second canes 52 may be undoped canes. Thus, when the second canes 52 are combined together with the first canes 50, it becomes possible to tune the Tm concentration per area of the final construction of the doped core 46, after the doped core 46 is heated 34 and drawn 36.

It is noted that the second canes 52 need not be undoped canes. Instead, the second canes 52 may be doped with a different Tm concentration. Still further, the second canes 52 may be doped with one or more elements that differ from Tm. For purposes of the present invention, the canes 50, 52 may be doped with any suitable materials so long as the selection of the dopants results in the creation of a doped core 46 and a doped cladding 48 that satisfy the requirement that the value for NA be ≤0.2, as discussed above.

In another embodiment differing from the embodiment illustrated in FIG. 7, the doped core 46 may be a solid core that was not manufactured using canes 50, 52. In this contemplated embodiment, the doped cladding 48 may be made from canes while the doped core 46 is not.

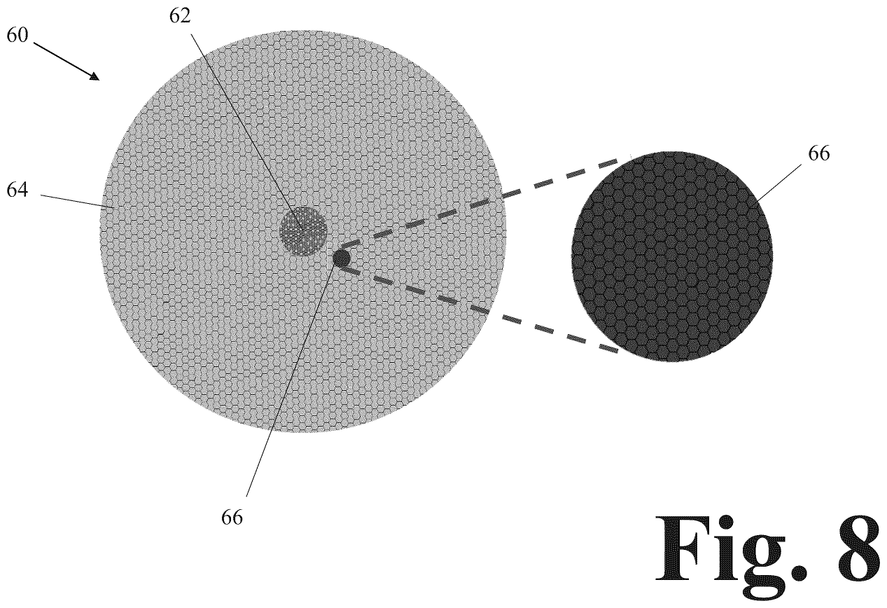

FIG. 8 is a graphical cross-section of a third embodiment of an optic fiber 60 created using canes 30 as illustrated in FIG. 5.

The optic fiber 60 includes a doped core 62 and a doped cladding 64. The doped core 62 is contemplated to be doped with Tm and the doped cladding 64 is contemplated to be doped with Ge or Al, as discussed above. The selection of the dopant for the doped core 62 and the doped cladding 64 is understood to establish a value for NA that is ≤0.2.

This embodiment of the optic fiber 60 includes a side core 66, which is typical for the construction of a Chirally Coupled Core (“3C”) optic fiber. A 3C optic fiber includes one or more side cores 66 that are helically wrapped around the central core, in this case the doped core 62.

In this embodiment, the doped core 62 has the same construction as the doped core 46 illustrated in FIG. 7.

The side core 66 is contemplated to have a RI that is higher than the RI of the doped cladding. However, the RI of the side core 66 need not be the same as the RI of the doped core 62.

In one contemplated variation, the side core 66 has the same construction as the doped core 62. However, numerous variations are contemplated to fall within the scope of the present invention.

Still further, like the variation of the optic fiber 44 illustrated in FIG. 7, the doped core 62 may be a solid core that was not manufactured using canes 50, 52. In this contemplated embodiment, the doped cladding 64 may be made from canes while the doped core 62 is not.

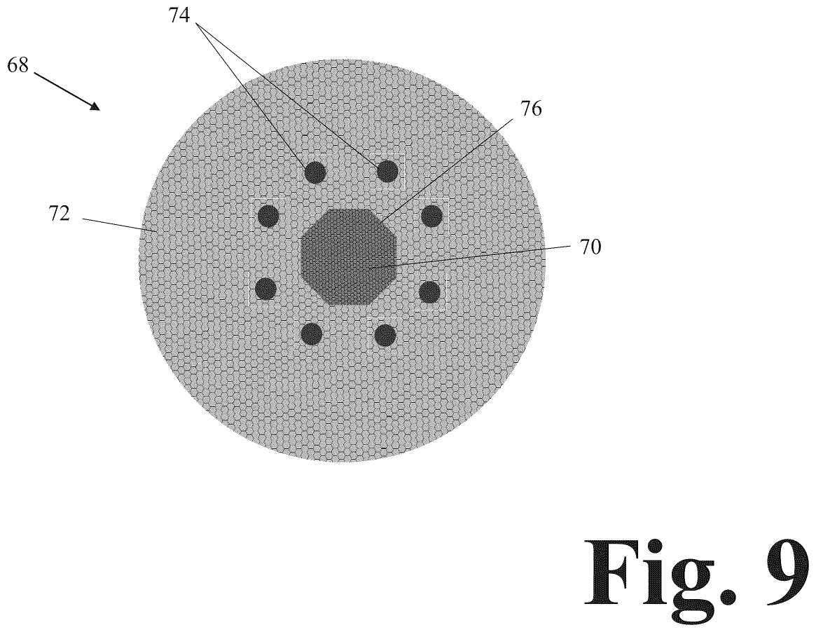

FIG. 9 is a graphical cross-section of a fourth embodiment of an optic fiber 68 created using canes 30 as illustrated in FIG. 5.

The optic fiber 68 includes a doped core 70 and a doped cladding 72. The doped core 70 is contemplated to be doped with Tm and the doped cladding 72 is contemplated to be doped with Ge or Al, as discussed above. As with other embodiments, the dopant for the doped core 70 and the doped cladding 72 are understood to establish a value for NA that is ≤0.2.

In this embodiment, the doped core 70 has a uniform construction as discussed in connection with the optic fiber 38 illustrated in FIG. 6. Here, however, the doped core 70 has a polygonal shape. In particular, the doped core 70 is an octagon with eight sides 76.

It is noted that the shape of the doped core 70 may have any polygonal shape or non-circular geometry without departing from the scope of the present invention. This includes, but is not limited to, any polygon with 3-20 sides. It is contemplated that polygons with more than 20 sides may be employed. However, as the number of sides increases above 20, the polygon begins to approximate the operational characteristics of a circular doped core, such as the doped core 40 illustrated in FIG. 6.

In this embodiment, there are eight side cores 74. In fact, it is contemplated that the number of side cores 74 equals the number of sides 76 of the polygon of the doped core 70.

It is noted that a one-to-one correlation between the number of side cores 74 and the number of sides 76 is not required to construct the optic fiber 68. The optic fiber 68 may encompass an arrangement where there are a greater number of side cores 74 than there are sides 76 to the polygonal doped core 70. The optic fiber 68 also may encompass an arrangement where there are a fewer number of side cores 74 than there are sides 76 to the polygonal doped core 70.

Concerning the various embodiments of the optic fiber 38, 44, 60, 68, it is contemplated that the doped claddings 42, 48, 64, 72 are constructed from canes 30, all of which are doped with Ge. Alternatively, some of the canes 30 may be doped with Ge while others are doped with Al. In yet another contemplated variation, the canes 30 may combine some canes doped with Ge, some canes 30 doped with Al, and some canes 30 that are not doped at all. In this manner, like the doped core 46, 62, the RI may be tuned to a predetermined value.

It is noted that there is at least one additional benefit that may be attributed to the use of canes 30 to construct the optic fibers 38, 44, 60, 68. Specifically, as may be appreciated by those skilled in the art, Tm-doped optic fibers that are used for amplifiers and lasers are known to suffer from excessive heating. It is understood that one reason for excessive heating lies in the high concentration of Tm needed for high quantum efficiency operation.

Currently, it is known that Tm-doped fibers cannot be employed with lasers that operate at powers greater than 1.2 kW in a continuous wave (“CW”) operation. A CW operation refers to the operation of a fiber laser that remains “on” continuously.

It is noted that the power of the laser(s) employed in connection the optic fiber 38, 44, 60, 68 of the present invention are contemplated to fall within a range of about 100 W-20 kW, which includes 100 W, 500 W, 1 KW, 2 KW, 3 KW, 4, kW, 5 KW, 6 KW, 7 kW, 8 kW, 9 KW, 10 kW, 11 kW, 12 kW, 13 kW, 14 kW, 15 kW, 16 kW, 17 kW, 18 kW, 19 kW, 20 kW or higher powers. It is noted that any range defined by any of these specific values also is contemplated to fall within the scope of the present invention.

As noted above, the doped cores 46, 62 may be constructed so that the Tm concentration may be tuned to avoid over-heating. As such, it is contemplated that the Tm concentration in the doped core 46, 62 may be adjusted to permit operation of a fiber laser at greater than 1.2 kW. Furthermore, judicious choice of the canes 30 for the Tm-doped core 46, 62 may be further tailored to accommodate the NA of the fundamental mode.

As should be apparent from the foregoing, the use of canes 30 also is understood to facilitate manufacture of 3C optic fibers 60, 68 without incorporating a pedestal 14 therein. Moreover, the use of canes 30 may facilitate the formation of a much tighter geometric accuracy for the placement of the side cores 66, 74 relative to the doped cores 62, 70.

Next, it is noted that the use of canes 30 may be particularly suited for the construction of 3C optic fibers 60, 68 where a size of the doped core 62, 70 is <40 micrometer (μm) in size. Where the doped core 62, 70 is less than 40 micrometers in size, the doped cores 62, 70 typically are circular. For 3C optic fibers 60, 68 where the doped cores 62, 70 are larger than 40 micrometers, the doped cores 62, 70 are typically octagonal in shape, as illustrated in FIG. 9, for example.

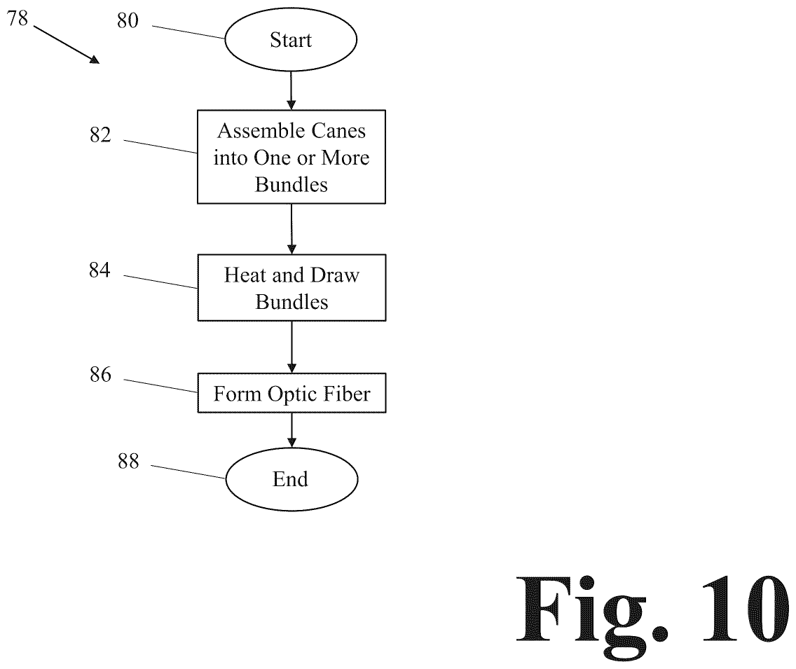

FIG. 10 is a flow chart that illustrates one method 78 contemplated to manufacture the optic fibers 38, 44, 60, 68 according to the present invention.

The method 78 starts at 80 and proceeds to a step 82 where the canes 30 are assembled into one or more cane bundles 32.

The method 78 proceeds to step 84 where the cane bundles 32 are heated and drawn.

The method 78 then proceeds to step 86 where the heated and drawn canes bundles 32 are formed into the optic fiber 38, 44, 60, 68.

The method ends at step 88.

As should be apparent to those skilled in the art, the method 78 is not limited solely to the steps 80-88 enumerated. One or more of the steps 80-88 may be separated into more than one step, for example. Moreover, additional steps may be employed without departing from the scope of the present invention.

As discussed hereinabove, the embodiments of the present invention are exemplary only and are not intended to limit the present invention. Features from one embodiment are interchangeable with other embodiments, as should be apparent to those skilled in the art. As such, variations and equivalents of the embodiments described herein are intended to fall within the scope of the claims appended hereto.

What is claimed is:

1. An optical fiber, comprising:
a doped core doped with thulium; and
a doped cladding surrounding the doped core doped with a second dopant;
wherein the doped cladding has a thickness between about 45 μm-650 μm, and wherein the doped core and the doped cladding establish a numerical aperture within a range of about 0.04-0.20.

2. The optical fiber according to claim 1, wherein the numerical aperture is within a range of about 0.04-0.14.

3. The optical fiber according to claim 1, wherein the numerical aperture is within a range of about 0.15-0.19.

4. The optical fiber according to claim 1, wherein the numerical aperture is within a range of about 0.16-0.18.

5. The optical fiber according to claim 1, wherein the numerical aperture is at least one of about 0.04, 0.05, 0.06, 0.07, 0.08, 0.09, 0.10, 0.11, 0.12, 0.13, 0.14, 0.15, 0.16, 0.17, 0.18, 0.19, or 0.20.

6. The optical fiber according to claim 1, wherein the doped cladding has a thickness between about 150 μm-250 μm.

7. The optical fiber according to claim 1, wherein the doped cladding has a thickness between about 550 μm-650 μm.

8. The optical fiber according to claim 1, wherein the doped cladding has a thickness that is selected from a group comprising: 45 μm, 50 μm, 100 μm, 150 μm, 200 μm, 250 μm, 300 μm, 350 μm, 400 μm, 450 μm, 500 μm, 550 μm, 600 μm, and 650 μm.

9. The optical fiber according to claim 1, wherein the second dopant is germanium.

10. The optical fiber according to claim 1, wherein the second dopant is aluminum.

11. The optical fiber according to claim 1, wherein the doped core comprises a first plurality of canes that are heated and drawn.

12. The optical fiber according to claim 1, wherein the doped cladding comprises a second plurality of canes that are heated and drawn.

13. The optical fiber according to claim 1, wherein:
the doped core comprises a first plurality of canes,
the doped cladding comprises a second plurality of canes,
wherein both the first plurality of canes and the second plurality of canes are heated and drawn.

14. The optical fiber according to claim 11, wherein:
the first plurality of canes comprises a third plurality of canes and a fourth plurality of canes,
wherein the third plurality of canes is doped with thulium at a first concentration,
wherein the fourth plurality of canes is doped with thulium at a second concentration, and
wherein the first concentration is not equal to the second concentration.

15. The optical fiber according to claim 14, wherein the fourth plurality of canes are undoped.

16. The optical fiber according to claim 12, wherein:
the second dopant is germanium,
the second plurality of canes comprises a fifth plurality of canes and a sixth plurality of canes,
wherein the fifth plurality of canes is doped with germanium at a third concentration,
wherein the sixth plurality of canes is doped with germanium at a fourth concentration, and
wherein the third concentration is not equal to the fourth concentration.

17. The optical fiber according to claim 16, wherein the sixth plurality of canes are undoped.

18. The optical fiber according to claim 12, wherein:
the second dopant is aluminum,
the second plurality of canes comprises a seventh plurality of canes and an eighth plurality of canes,
wherein the seventh plurality of canes is doped with aluminum at a fifth concentration, wherein the eighth plurality of canes is doped with germanium at a sixth concentration, and
wherein the fifth concentration is not equal to the sixth concentration.

19. The optical fiber according to claim 18, wherein the eighth plurality of canes are undoped.
